(19) United States
(12) Patent Application Publication
(10) Pub. No.: US 2011/0299963 A1
(43) Pub. Date: Dec. 8, 2011

(54) LOWERABLE TRAILER

(76) Inventors: BRADLEY AUBREY, Oak Hills, CA (US); CARLOS AGRUSA, Victorville, CA (US)

(21) Appl. No.: 12/796,419

(22) Filed: Jun. 8, 2010

(51) Int. Cl. B60P 1/08

(52) U.S. Cl. 414/484; 280/414.5

(57) ABSTRACT

Improvements in a lowerable trailer that uses pneumatic cushions to provide both the cushioning of the trailer bed and raising and lower of the trailer bed. The air in the pneumatic cushions can be vented to allow the bed of the trailer to lay flat on the ground. Another pneumatic cushion changes the angle of the bed to the tongue to ensure that both the front and the back of the bed come in contact with the ground. The lowerable trailer is ideal for the transportation of custom vehicles to and from an auto show where the custom vehicles may have limited ground clearance. The pneumatic cushions can be filled with a standard hand pneumatic hand pump or with an air compressor that can be powered by a car battery or an electrical outlet.

### CROSS REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a trailer. More particularly, the present trailer uses air filled cushions to suspend the bed of a trailer that can be deflated to allow the entire bed frame of the trailer to rest on the ground.

2. Description of Related Art Including Information Disclosed Under 37 CFR 1.97 and 1.98

When transporting a number of trailerable items such a custom vehicles the ground clearance of the transported vehicle is often limited. Moving a custom vehicle on and off of a trailer can often be difficult and can result in damage to the vehicle if the vehicle scrapes on the ground and this can be expensive to repair. One of the best ways to move these expensive vehicles on and off of a trailer is for the bed of the trailer to lay flat on the ground. This minimizes the required ground clearance and makes it safer to move the vehicle on and off of the trailer. Several products and patents have been issued or pending on trailers where some or all of the bed lowers to make it easier to get a vehicle on or off of the trailer. Exemplary examples of patents covering these products are disclosed herein.

U.S. Pat. No. 5,433,578 issued Jul. 18, 1995 to William Homan Jr., discloses a Retractable Suspension. The retractable suspension moves the leaf springs up into the frame to lower the bed of the trailer. As the suspension is retracted a link pulls the tow arm to lower the front of the trailer. While this patent allows the bed of the trailer to be lowered, the patent requires a complicated linkage of mechanisms.

U.S. Pat. No. 2,230,014 issued to P. H. Raven on Jan. 28, 1941 and U.S. Pat. No. 5,536,131 issued Jul. 16, 1996 to Albert Behr both disclose trailers where the bed of the trailer is attached to a pair of parallel arms that swing an inner bed down to the ground. The inner bed is raised and lowered by either a cable or a pressurized cylinder. Both of these patents use a single axle of wheels and require two sets of frames that add complexity and the cost of making the trailer.

U.S. Pat. No. 5,308,213 issued May 3, 1994 to Gerald M. Gilbertson, U.S. Pat. No. 5,474,416 issued Dec. 12, 1995 to Michael E. Roggee et al and U.S. Pat. No. 5,810,544 issued Sep. 22, 1998 to Phillip Wellman all disclose a trailer with a separate bed that is raised and lowered with a cable system. The cable system must be strong enough to lift not only the internal bed but must also be strong enough to lift anything that is loaded onto the movable bed. While these patents allow for ground level loading onto the trailer the trailer requires a complex cable elevating system and limited cushioning to anything placed onto the transportation platform.

What is needed is a trailer where the bed of the trailer can be easily raised and lowered. The ideal trailer would provide cushioning to the load in the trailer. Using one or more bladders to provide both the elevation and the cushioning will provide an improved ride and the inflatable bladders can be raised with a plug in air compressor that is commonly available and used when transporting a vehicle on the trailer.

### BRIEF SUMMARY OF THE INVENTION

It is an object of the lowerable trailer to have a pneumatic suspension system. The pneumatic suspension system allows the amount of cushioning to be adjusted based upon the weight of the load as well as the amount of desired cushion. A pneumatic suspension system can also be easily modified to raise or lower the transportation height of the material within the bed to increase ground clearance. The height of the pneumatic suspension can also be adjusted to hatch the height of the hitch on the tow vehicle.

It is an object of the lowerable trailer to include a pneumatic lift that can change the elevation of the bed from ground level to transportation height. This adjustment can place the bed at the lowest minimum height to allow vehicles of very low ground clearance to be rolled or driven onto the bed with limited fear that the front or back of the transported vehicle will scrape the ground and cause potential harm to the vehicle that is being transported on the trailer.

It is another object of the lowerable trailer to include a pneumatically adjustable tongue. The ability to change the angle of the tongue to the hitch and the bed is important to ensure that the transportation bed is flat or level with the ground. Using a pneumatic adjustment for the tongue allows for both a cushioned connection from the tongue to rotate relative to the bed to reduce motion that is transferred from the tow vehicle to the trailer.

It is another object of the lowerable trailer to have a level deck. The pneumatic cushioning system allows for one pair or multiple pairs of tires to the used and pressure of each pneumatic pillow can be adjusted to change the angle of the bed as well as account for the location where the load is placed onto the bed.

It is still another object of the lowerable trailer to use air to adjust the pressure in the pneumatic cushions. The use of pneumatic pressure is ideal because at car shows the use of small and or large air compressors is readily available to fill the tires of vehicles. To fill the pneumatic cushion the user just needs manual pump that can be attached to a standard tire valve located on the cushion.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a side view of a two wheel lowerable trailer showing the frame in a raised orientation and in a phantom lowered orientation for a first preferred embodiment.

FIG. 2 shows a top view of the two wheeled lowerable trailer from FIG. 1.

FIG. 3 shows top view of the four wheeled lowerable trailer from a second preferred embodiment.

FIG. 4 shows a side view of the four wheeled lowerable trailer from FIG. 3 with the retracted wheels and tongue shown in phantom.

FIG. 5 shows a detailed perspective view of the pivoting tongue.

FIG. 6 shows a detailed perspective view of a pivoting wheel.

### DETAILED DESCRIPTION OF THE INVENTION

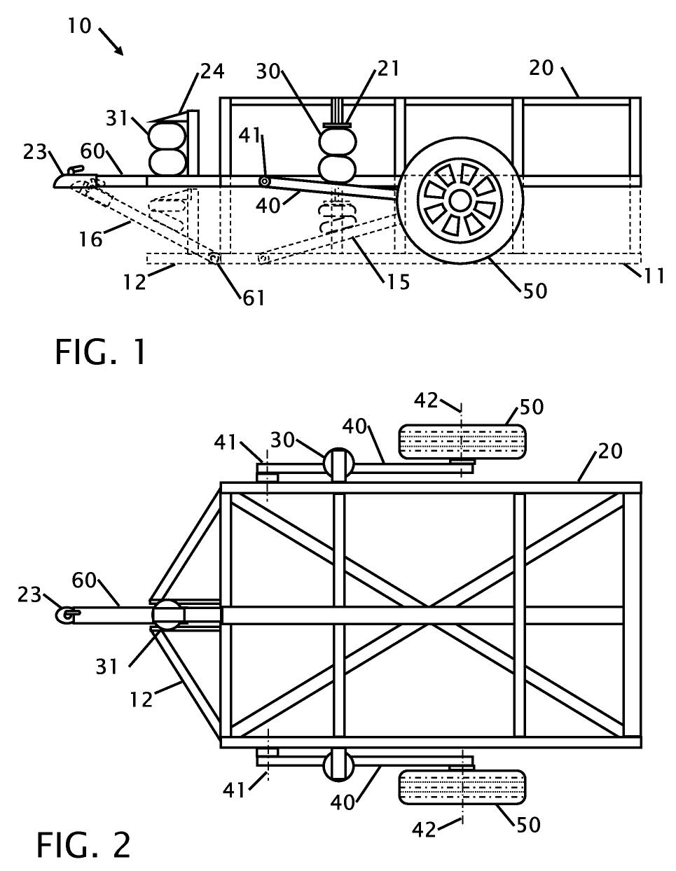

FIG. 1 shows a side view of a two wheel lowerable trailer showing the frame in a raised orientation and in a phantom lowered orientation for a first preferred embodiment, and FIG. 2 shows a top view of the two wheeled lowerable trailer from FIG. 1. From FIG. 1 the trailer 10 is shown with solid lines and in phantom dashed lines with the frame lowered 11. It should be clear from this figure that when the frame 20 is lowered both the front and back of the frame bed is placed in full contact with the ground. This provides the lowest ground clearance for installing and removing items from the bed of the trailer. The phantom dash lines show the wheel raised 15 and the tongue raised 16.

The tongue of the trailer pivots separately from the bed to allow the trailer to remain in contact with the tow vehicle to thereby reducing the amount of time and effort that is required to unhitch and re-hitch the hitch socket onto the tow vehicle from the hitch socket 23. From these figures the frame 20 is shown constructed from tubular members. The frame 20 is elevated around the bed of the trailer 10. While the configuration shown is for an outer frame 20 that is between about one and two feet tall, it is contemplated that no railing or a lowered railing as well as high and complete side walls can be used with the trailer sides. The railing 20 provides some structural rigidity to the trailer 10.

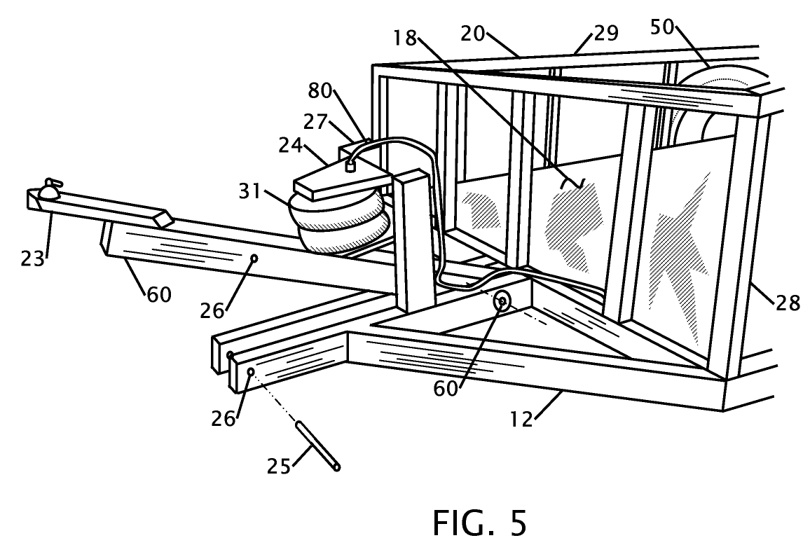

In the front of the trailer the tongue 60 pivots on the frame tongue extension 12 at tongue pivot axis 61. One or more bladders 31 are supported at one end on tongue pneumatic bladder support 31 that is rigidly connected to the frame 20 of the trailer 10 with the tongue pneumatic support 24. In the embodiment shown two pneumatic bladders 31 are shown stacked in series to provide greater extension, but as few as one to more than two bladders are contemplated. While the bladders are shown stacked in series, it is also contemplated that multiple bladders can be connected in parallel to increase the lifting force. The connection of the tongue to the trailer is shown and described in more detail with FIG. 5 herein.

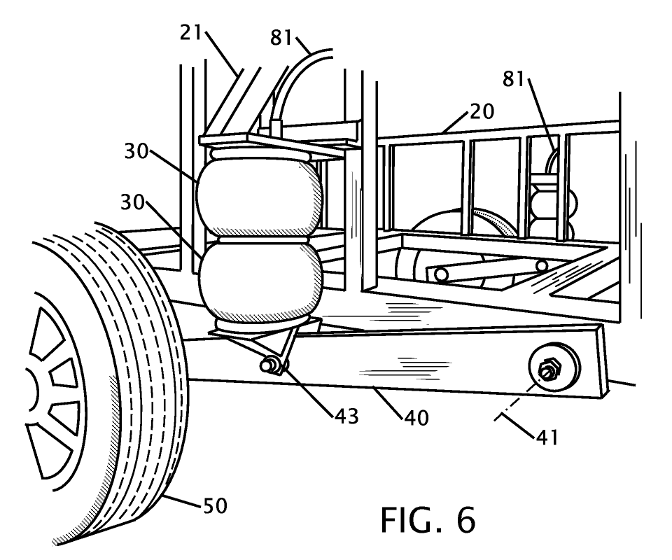

The wheel(s) 50 are mounted on a suspension arm 40 that pivots 41 to raise and lower the bed and frame 20 of the trailer 10. The wheel(s) 50 independently spin on wheel spin axis 42. Because the wheels are mounted on the outside of the trailer frame 20 they move independent of the frame and the frame 20 can be made as a single structural unit whereby allowing the trailer 10 to support a greater load. The suspension arm pivots on the frame 20 through pivot point 41 and one or more pneumatic bladders 30 provide both a cushioned suspension and the ability to raise and lower the bed/frame 20 of the trailer. The pneumatic bladders 30 are secured to the frame 20 at a wheel pneumatic bladder support 21 that is rigidly secured to the frame 20. The connection of the suspension arm 40 to the trailer is shown and described in more detail with FIG. 6 herein.

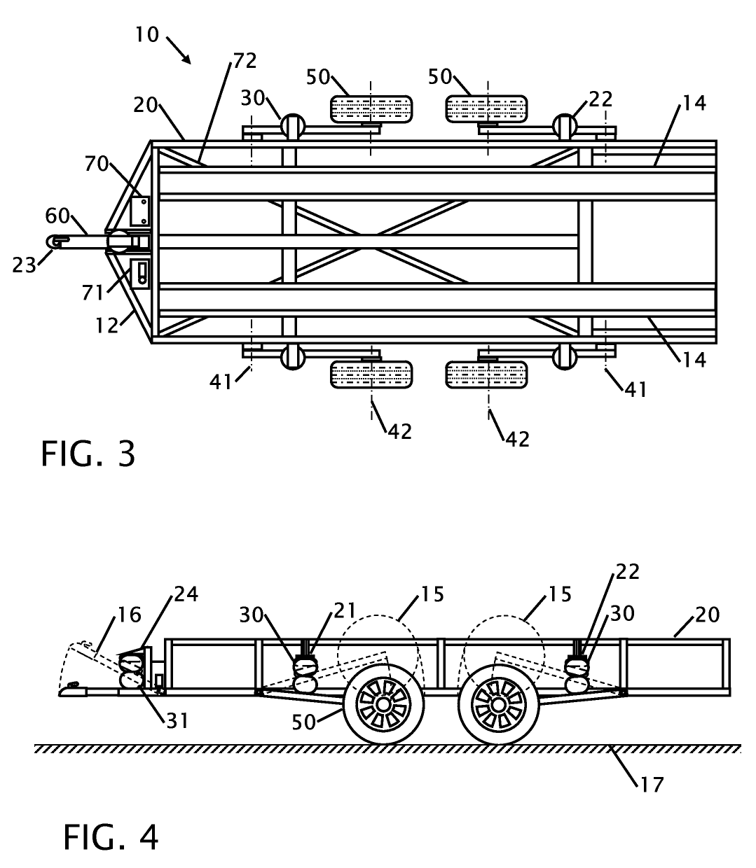

FIG. 3 shows top view of the four wheeled lowerable trailer from a second preferred embodiment and FIG. 4 shows a side view of the four wheeled lowerable trailer from FIG. 3 with the retracted wheels and tongue shown in phantom. From FIG. 4 the trailer 10 is shown with solid lines with the wheels 50 on the ground 17 and in phantom dashed lines with the wheels 15 and the tongue 16 lifted into the frame 20. It should be clear from this figure that when the frame 20 is lowered both the front and back of the frame bed is placed in full contact with the ground. This provides the lowest ground clearance for installing and removing items from the bed of the trailer.

The tongue of the trailer pivots separately from the bed to allow the trailer to remain in contact with the tow vehicle to thereby reducing the amount of time and effort that is required to unhitch and re-hitch the hitch socket onto the tow vehicle from the hitch socket 23. From these figures the frame 20 is shown constructed from tubular members. The frame 20 is elevated around the bed of the trailer 10. While the configuration shown is for an outer frame 20 that is between about one and two feet tall, it is contemplated that no railing or a lowered railing as well as high and complete side walls can be used with the trailer sides. The railing 20 provides some structural rigidity to the trailer 10. FIG. 3 shows that the bed of the trailer is configured with car ramps 14 that help to maintain a car or other wheeled vehicle positioned within the bed of the trailer 10. In the preferred embodiment the distance between the car ramps is adjustable to accommodate different width wheel basses of the vehicles that will be transported on the trailer 10. The frame 10 can be fabricated with anchor tie downs 72 to secure items onto the bed of the trailer 10.

In the front of the trailer the tongue 60 pivots on the frame tongue extension 12 at tongue pivot axis 61. One or more bladders 31 are supported at one end on tongue pneumatic bladder support 31 that is rigidly connected to the frame 20 of the trailer 10 with the tongue pneumatic support 24. In the embodiment shown two pneumatic bladders 31 are shown stacked in series to provide greater extension, but as few as one to more than two bladders are contemplated. While the bladders are shown stacked in series, it is also contemplated that multiple bladders can be connected in parallel to increase the lifting force. The connection of the tongue to the trailer is shown and described in more detail with FIG. 5 herein.

The wheel(s) 50 are mounted on a suspension arm 40 that pivots 41 to raise and lower the bed and frame 20 of the trailer 10. The wheel(s) 50 independently spin on wheel spin axis 42. Because the wheels are mounted on the outside of the trailer frame 20 they move independent of the frame and the frame 20 can be made as a single structural unit whereby allowing the trailer 10 to support a greater load. The suspension arm pivots on the frame 20 through pivot point 41 and one or more pneumatic bladders 30 provide both a cushioned suspension and the ability to raise and lower the bed/frame 20 of the trailer. The pneumatic bladders 30 are secured to the frame 20 at a wheel pneumatic bladder support 21/22 that is rigidly secured to the frame 20. The connection of the suspension arm 40 to the trailer is shown and described in more detail with FIG. 6 herein.

While FIGS. 3 and 4 show two axles of wheels, for a total of four wheels, it is contemplated that additional wheel axis can be added to further increase the load carrying capacity of the trailer 10. The pneumatic bladders 30 can be pneumatically connected together or independently. With the pneumatic bladders 30 are connected together, they can all be filled from the same connection or air supply. If the pneumatic bladders 30 are independent the amount of cushion can be adjusted to balance the load as well as alter the amount of load on the tongue or hitch socket 23.

In FIGS. 3 and 4 the front of the trailer is shown with a battery 70 and an air compressor 71 a pressure gauge and or a connection for connecting an external air supply. The pneumatic bladders have one or more air relief valves to vent air within the pneumatic bladders to lower the trailer frame. The inclusion of these two components allows the trailer to be self contained whereby the trailer can fill or maintain the pressure in the pneumatic bladders. The height of the trailer bed can be altered by changing the amount of air pressure within each pneumatic suspension bladder(s) 30. It is contemplated that a series of hoses connect the pneumatic bladders and that the hoses are attached externally to the frame or are passed through the frame to provide protection to the hoses.

FIG. 5 shows a detailed perspective view of the pivoting tongue. The frame 20 has a frame tongue extension 12 that provides a forked extension where the pivoting tongue 60 is supported between the forks. When the pneumatic bladder 31 is filled, the tongue 60 will rotate into a horizontal orientation and a locking pin 25 is passed through a series of holes 26 that are located in both the frame tongue extension and the pivoting tongue 60 the pin locks the tongue and prevents rotation of the pivoting tongue 60. The pivoting tongue 60 terminates at one end with a hitch socket 23 and at the other end at a pivotal axis 60 where it is secured to the frame 20.

The pivoting tongue is raised and lowered with pneumatic bladder(s) 31 that are secured to the pivoting tongue with a pivoting connector, and are secured to the frame of the trailer with a tongue pneumatic bladder support 24 that is welded to risers 27 that are welded to the frame 20.

The trailer in this figure is configured with a flat deck 18 with a series of uprights 28 that are secured or welded to create the frame 20 with a top railing 29. A portion of one of the tires 50 is visible in this figure. This figure shows a filling hose 80, but it is also contemplated that the pneumatic bladders can be filled without an attached hose by connecting an air filling line.

FIG. 6 shows a detailed perspective view of a pivoting wheel. The wheel(s) 50 are mounted on a suspension arm 40 that pivots 41 to raise and lower the bed and frame 20 of the trailer. Because the wheels are mounted on the outside of the trailer frame 20 they move independent of the frame 20. The suspension arm pivots on the frame 20 through pivot point 41 and one or more pneumatic bladders 30 provide both a cushioned suspension and the ability to raise and lower the bed/frame 20 of the trailer. The pneumatic bladders 30 are secured to the frame 20 at a wheel pneumatic bladder support 21 that is rigidly secured to the frame 20. A pivot 43 allows the pneumatic bladder(s) to rotate on the suspension arm 40 to allow the pneumatic bladders to compress and expand on their parallel faces. Filling hoses 81 connect wheel groups on both sides of the trailer frame 20.

Thus, specific embodiments of a lowerable trailer have been disclosed. It should be apparent, however, to those skilled in the art that many more modifications besides those described are possible without departing from the inventive concepts herein. The inventive subject matter, therefore, is not to be restricted except in the spirit of the appended claims.

1. A lowerable trailer comprising:
a trailer frame;
at least one set of tires that are rotationally connected to said trailer frame with an arm on each tire;
at least one pneumatic bladder connected between each of said arms and said trailer frame to raise and power said trailer frame;
a tongue that is pivotably connected to said trailer frame;
a tongue pneumatic bladder that is positioned to adjust an angle between said tongue and said trailer frame whereby said tongue pneumatic bladder allows said tongue to angle between a hitch and said trailer frame, whereby
said at least one pneumatic bladder and said tongue pneumatic bladder can be vented to allow said trailer frame to rest on a ground level for a loading/unloading position and filled to elevate said trailer to a transportation position.

2. The lowerable trailer according to claim 1 that further includes an air compressor.

3. The lowerable trailer according to claim 1 that further includes a pressure gauge.

4. The lowerable trailer according to claim 1 that further includes a hitch receptor that is secured to said tongue.

5. The lowerable trailer according to claim 1 wherein each of said at least one pneumatic bladder connected between each of said arms and said trailer is connected to a common filling hose.

6. The lowerable trailer according to claim 1 wherein each of said at least one pneumatic bladder connected between each of said arms and said trailer is connected to a separate filling hose to allow a pressure within each pneumatic bladder to be individually pressurized.

7. The lowerable trailer according to claim 1 wherein said pneumatic bladder is more than one bladder connected in series.

8. The lowerable trailer according to claim 1 wherein said pneumatic bladder is more than one bladder connected in parallel.

9. The lowerable trailer according to claim 1 wherein said at least one pneumatic bladder that is connected between each of said arms and said trailer frame is pivotably connected to said frame.

10. The lowerable trailer according to claim 1 wherein said tongue pneumatic bladder that is positioned to adjust an angle between said tongue and said trailer frame is pivotably connected to said frame.

11. The lowerable trailer according to claim 1 wherein said tongue and said from further includes a locking pin that secures said tongue to said frame whereby eliminating angular rotation of said tongue with said frame.

12. The lowerable trailer according to claim 1 that further includes car wheel ramps.

13. The lowerable trailer according to claim 12 wherein a distance between said car wheel ramps is adjustable.

14. The lowerable trailer according to claim 1 wherein said frame is constructed from welded steel.

15. The lowerable trailer according to claim 1 wherein said frame further includes raised side members.

16. The lowerable trailer according to claim 1 wherein said frame has a solid flat deck.

17. The lowerable trailer according to claim 1 that further includes anchor tie downs.

18. The lowerable trailer according to claim 1 wherein said tires pivot external of said frame.

19. The lowerable trailer according to claim 1 further includes an air relief valve.

20. The lowerable trailer according to claim 1 wherein said pneumatic bladders are adjustable to alter the load carrying capability of said trailer and or the elevated height of said trailer frame.
